(19) United States
(12) Patent Application Publication
(10) Pub. No.: US 2010/0000837 A1
(43) Pub. Date: Jan. 7, 2010

(54) POS SYSTEM, METHOD FOR CONTROLLING POS SYSTEM, AND CHANGE DISPENSER

(75) Inventors: Toki Hokazono, Inagi (JP); Takashi Toyokawa, Inagi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: FUJITSU LIMITED, Kawasaki-shi (JP); FUJITSU FRONTECH LIMITED, Tokyo (JP)

(21) Appl. No.: 12/558,926

(22) Filed: Sep. 14, 2009

Related U.S. Application Data
(63) Continuation of application No. PCT/JP2008/054390, filed on Mar. 11, 2008.

(30) Foreign Application Priority Data
Mar. 15, 2007 (JP) 2007-067440

(51) Int. Cl. G07F 9/00

(52) U.S. Cl. 194/200

(57) ABSTRACT

When a goods registration process is executed in a POS terminal and money is jammed in a deposited-money conveying device after a deposit is received through an input port of a coin/bill dispenser, the coin/bill dispenser transmits an error notification to the POS terminal. When receiving the error notification, the POS terminal sets a deposit-amount fixing mode to a manual input mode, calculates, when a deposit amount is input and a total key is pressed by an operator, a change amount by using an input deposit amount and a sales amount totalized during the goods registration process, and transmits change information including the change amount to the coin/bill dispenser. The coin/bill dispenser causes a storage device to dispense change therefrom based on the change amount and ejects the change through an ejection port.

### CROSS-REFERENCE TO RELATED APPLICATION(S)

This application is a continuation of International Application No. PCT/JP2008/054390, filed on Mar. 11, 2008 which claims the benefit of priority from Japanese Patent Application No. 2007-067440, filed on Mar. 15, 2007, the entire contents of which are incorporated herein by reference.

### FIELD

The embodiment discussed herein is directed to a POS system that includes a POS terminal and a change dispenser, a method for controlling the POS system, and a change dispenser connectable to the POS terminal.

### BACKGROUND

A point-to-sale (POS) system is widely used as a system for settlement of goods purchased by a customer. This type of POS system also includes a POS system in which a change dispenser is connected to a PO terminal. Japanese Laid-open Patent Publication No. 2004-362163 discloses a technology for the POS system in which the change dispenser is connected to the PO terminal. In this POS system, if there are various denominations of money in deposit, some of which are not accepted by the change dispenser, an operator manually, additionally inputs an amount of not-accepted money so as to be added to the deposit which is calculated by the change dispenser. The change dispenser is generally used as a change dispenser for handling coins, but a so-called “bill dispenser” for handling bills and a so-called “coin/bill dispenser” for handling coins and bills are also included in the change dispenser.

In the POS system in which the change dispenser is connected to a conventional POS terminal, if a jam of the deposit has occurred in the change dispenser, a checkout process in execution may not be continued unless the jam is cleared. This keeps the customer waiting until the jam is cleared. Such a trouble may also occur in the POS system described in Japanese Laid-open Patent Publication No. 2004-362163.

### SUMMARY

According to an aspect of an embodiment of the invention, a POS system includes a POS terminal; and a change dispenser. The change dispenser includes a storage device that stores therein money; a deposited-money conveying device that conveys money received through an input port to the storage device; a dispensed-money conveying device that conveys money dispensed from the storage device to an ejection port; a detector that detects a jam of money conveyed in the deposited-money conveying device; an error-notification transmitter that transmits, when the jam of the money is detected by the detector, an error notification indicating the detection of the jam of the money to the POS terminal; and a dispensing controller that causes, when receiving change information transmitted from the POS terminal as a response to the error notification, the dispensed-money conveying device to eject money corresponding to an amount of change included in the change information. The POS terminal includes a mode setting unit that sets, when receiving the error notification transmitted from the change dispenser, a deposit-amount fixing mode for fixing an amount of deposit to a manual input mode for fixing an input value input by an operator as the amount of deposit; a change-amount calculator that calculates, when the deposit-amount fixing mode is the manual input mode, an amount of change by using the input value input by the operator; and a change-information transmitter that transmits the change information including the amount of change calculated by the change-amount calculator to the change dispenser.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of a system configuration and a hardware configuration of a POS system;

FIG. 2 is an external perspective view of a coin/bill dispenser;

FIG. 3 is a diagram of a functional configuration of the coin/bill dispenser according to an embodiment of the present invention;

FIG. 4 is a diagram of a functional configuration of a POS terminal according to the embodiment of the present invention;

FIG. 5 is a flowchart of a procedure of the POS system according to the embodiment of the present invention; and

FIG. 6 is a structure diagram of an upper inner side of the coin/bill dispenser.

### DESCRIPTION OF EMBODIMENT

Preferred embodiments of the present invention will be explained with reference to accompanying drawings.

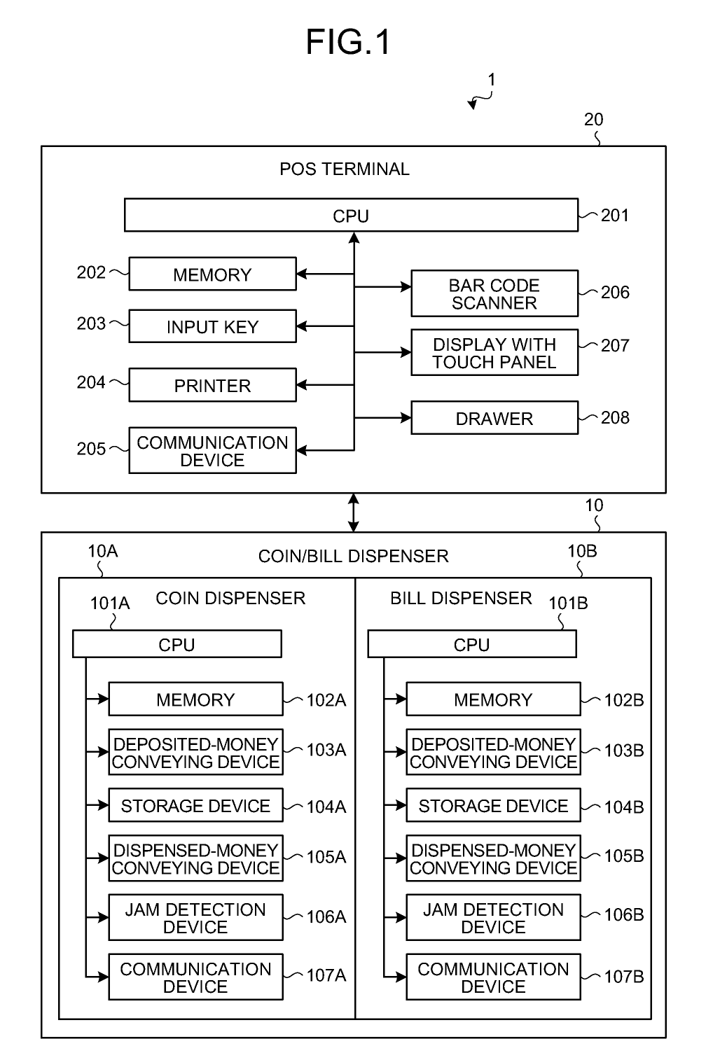

First, a configuration of a POS system according to an embodiment of the present invention is explained below. FIG. 1 is a diagram of a system configuration and a hardware configuration of a POS system 1. As represented in FIG. 1, the POS system 1 includes a coin/bill dispenser 10 and a POS terminal 20.

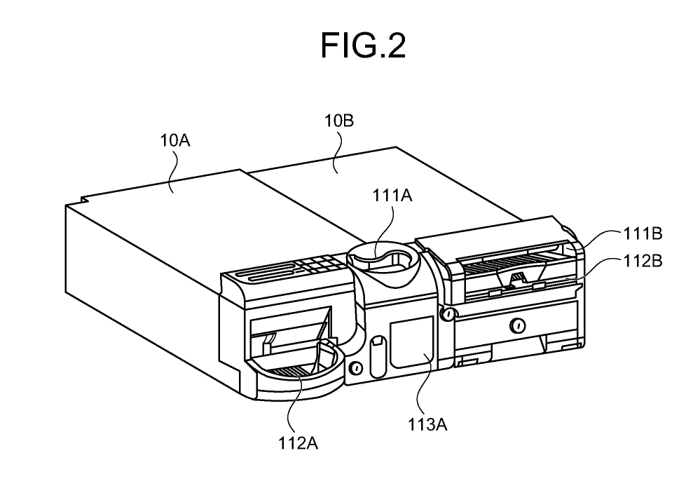

The coin/bill dispenser 10 is a device operable in association with the POS terminal 20. More specifically, for example, the POS terminal 20 performs a process for registering goods purchased by a customer, and when a bill or a coin is input into an input port of the coin/bill dispenser 10, change as an amount of money by subtracting a sales amount from the input amount of money is ejected through an ejection port. FIG. 2 is an external perspective view of the coin/bill dispenser 10. As illustrated in FIG. 2, the coin/bill dispenser 10 includes a coin dispenser 10A and a bill dispenser 10B. The coin dispenser 10A is a device that takes in a coin input through an input port 111A and ejects a coin through an ejection port 112A or through a return port 113A. The bill dispenser 10B is a device that takes in a bill input through an input port 111B and ejects a bill through an ejection port 112B that also functions as a return port. As represented in FIG. 1, the coin dispenser 10A and the bill dispenser 10B physically include central processing units (CPUs) 101A and 101B, memories 102A and 102B, deposited-money conveying devices 103A and 103B, storage devices 104A and 104B, dispensed-money conveying devices 105A and 105B, jam detection devices 106A and 106B, and communication devices 107A and 107B, respectively.

The deposited-money conveying devices 103A and 103B convey money received from the input ports 111A and 111B to the storage devices 104A and 104B, respectively. Each of the storage devices 104A and 104B has storage areas divided by each denomination of money, and stores each denomination of money in the corresponding storage area. The dispensed-money conveying devices 105A and 105B convey money dispensed from the storage devices 104A and 104B to the ejection ports 112A and 112B, respectively. The jam detection devices 106A and 106B detect a jam of the money in the deposited-money conveying devices 103A and 103B, the storage devices 104A and 104B, and the dispensed-money conveying devices 105A and 105B, respectively. The communication devices 107A and 107B are communication interfaces for controlling communications with an external device, for example, the POS terminal 20.

Here, the coin dispenser 10A and the bill dispenser 10B according to the embodiment are characterized in that the deposited-money conveying devices 103A and 103B are separately provided from the dispensed-money conveying devices 105A and 105B respectively, and in that the side of the deposited-money conveying devices 103R and 103B and the side of the dispensed-money conveying devices 105A and 105B can be operated independently. Therefore, for example, even if the money is jammed in the side of the deposited-money conveying devices 103A and 103B to cause failure, the side of the dispensed-money conveying devices 105A and 105B can operate without trouble. The first embodiment is characterized in that, to make effective use of the coin dispenser 10A and the bill dispenser 10B with such characteristics, even if the money is jammed in the side of the deposited-money conveying devices 103A and 103B, the change can be ejected by operating the dispensed-money conveying devices 105A and 105B which can normally operate.

The POS terminal 20 is a device that performs a registration process or the like of goods purchased by the customer. The POS terminal 20 physically includes a CPU 201, a memory 202, an input key 203, a printer 204, a communication device 205, a bar code scanner 206, a display 207 with touch panel, and a drawer 208.

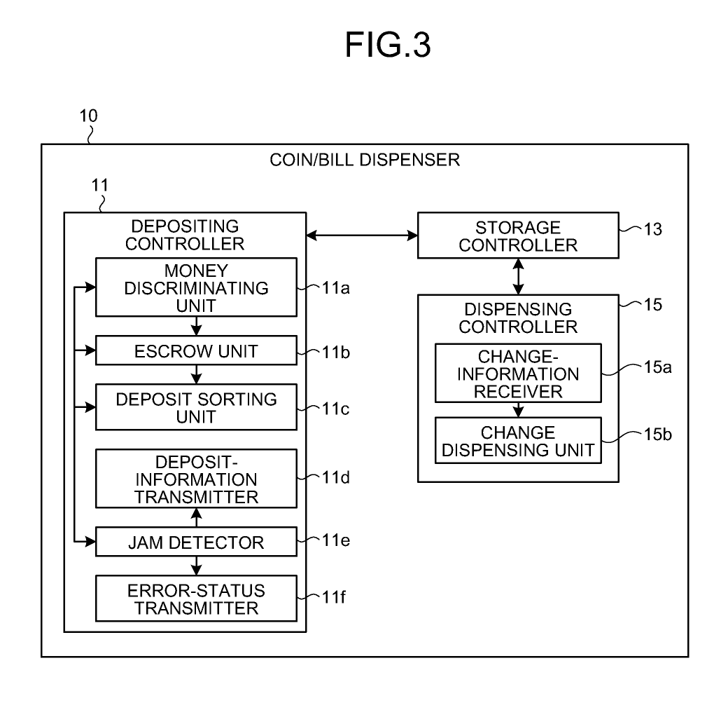

FIG. 3 is a diagram of a functional configuration of the coin/bill dispenser 10 according to the embodiment of the present invention. Here, because the coin dispenser 10A and the bill dispenser 10B have the same configuration as each other, in the followings, the functional configurations of the coin dispenser 10A and the bill dispenser 10B will not be discretely explained, but will be integrally explained as the functional configuration of the coin/bill dispenser 10.

As represented in FIG. 3, the coin/bill dispenser 10 has a deposing controller 11 as a function in the side of a deposited-money conveying device 103, a storage controller 13 as a function in the side of a storage device 104, and has a dispensing controller 15 as a function in the side of a dispensed-money conveying device 105. A CPU 101 executes a program stored in a memory 102 to function these controllers.

The depositing controller 11 controls process from receiving money through an input port 111 to storing the money in the storage device 104. The depositing controller 11 includes a money discriminating unit 11a, a escrow unit 11b, a deposit sorting unit 11c, a deposit-information transmitter 11d, a jam detector 11e, and an error-status transmitter 11f.

The money discriminating unit 11a has a totalizing function of discriminating a denomination of a deposit received through the input port 111 and totalizing the amount of deposit. The escrow unit 11b temporarily holds the deposits after the amount of the deposit is totalized by the money discriminating unit 11a.

The deposit sorting unit 11c causes the storage device 104 to store therein the deposit temporarily held in the escrow unit 11b. More specifically, the deposit sorting unit 11c sorts deposits into their denominations so that bills or coins of denominations corresponding to their respective storage areas of the storage device 104 divided by denomination are stored in the corresponding storage areas thereof, based on the denominations discriminated by the money discriminating unit 11a.

The deposit-information transmitter 11d transmits deposit information including the amount of deposit totalized by the money discriminating unit 11a to the POS terminal 20.

The jam detector 11e determines whether a jam of money has occurred in the deposited-money conveying device 103. More specifically, the jam detector 11e determines that the jam has occurred when a jam detection device 106 detects the jam of money.

When the jam detector 11e detects that the jam has occurred, the error-status transmitter 11f transmits an error notification indicating the detection of the jam to the POS terminal 20. Meanwhile, when the jam is cleared by fixing or so, the error-status transmitter 11f transmits an error release notification indicating the clearance of the jam to the POS terminal 20.

The storage controller 13 causes bills or coins of denominations corresponding to the storage areas of the storage device 104 divided by denomination, to be stored in the divided storage areas.

The dispensing controller 15 controls process from dispensing money from the storage device 104 to ejecting the money through an ejection port 112. The dispensing controller 15 includes a change-information receiver 15a and a change dispensing unit 15b.

The change-information receiver 15a receives change information transmitted from the POS terminal 20. The change information is transmitted from the POS terminal 20 when the POS terminal 20 instructs the coin/bill dispenser 10 to eject the change. The change information includes the amount of change.

The change dispensing unit 15b dispenses change from the storage device 104 based on the amount of change contained in the change information received by the change-information receiver 15a, and ejects the change through the ejection port 112.

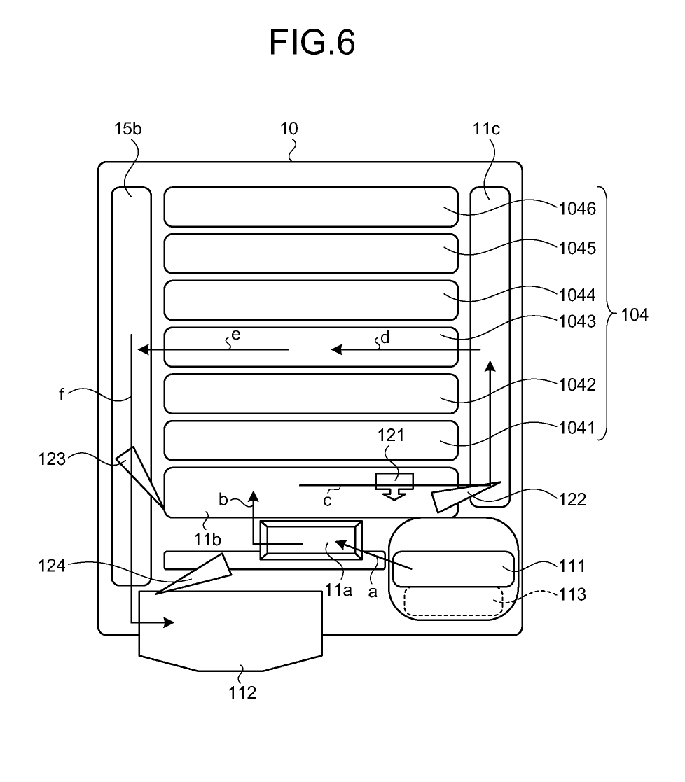

FIG. 6 is a structure diagram of an upper inner side of the coin/bill dispenser. As illustrated in FIG. 6, a deposited-money conveying path formed by the deposited-money conveying device 103 includes a path “a” from the input port 111 to the money discriminating unit 11a, a path “b” from the money discriminating unit 11a to the escrow unit 11b, a path “c” from the escrow unit 11b to the deposit sorting unit 11c, and a path “d” from the deposit sorting unit 11c to the storage device 104. Provided in the storage device 104 are a 1-yen storage 1041, a 50-yen storage 1042, a 5-yen storage 1043, a 100-yen storage 1044, a 10-yen storage 1045, and a 500-yen storage 1046. For example, when a 5-yen coin is input through the input port 111, the 5-yen coin passes through the path a to be conveyed to the money discriminating unit 11a. When the denomination of the coin is discriminated as the 5-yen coin by the money discriminating unit 11a, and then the 5-yen coin passes through the path b to be conveyed to the escrow unit 11b, where it is temporarily held.

When the transaction is settled, then the coin held in the escrow unit 11b is conveyed by driving the path c and the path d. For example, the 5-yen coin is conveyed by the deposited-money conveying path in which the 5-yen coin passes through the path c and passes through the path d switched by a storage switching gate 122 to be stored in the 5-yen storage 1043. If the 5-yen coin is jammed in the deposited-money conveying path, a forward blocking gate 121 is closed. In this case, conveyance of the money is blocked until the jam is cleared and the forward blocking gate 121 is opened. When it is determined by the money discriminating unit 11a that the input money is not accepted, a conveying destination of the path b is switched by a reject switching gate 124 from the escrow unit 11b to a return port 113, and the input coin is ejected to the return port 113.

Furthermore, when the transaction is not settled and the money is to be returned, the conveying destination is switched by a dispensed-money switching gate 123 from the escrow unit 11b to the ejection port 112 side, and the coin held in the escrow unit 11b is ejected to the ejection port 112.

Meanwhile, a dispensed-money conveying path formed by the dispensed-money conveying device 105 includes a path “e” from the storage device 104 to the change dispensing unit 15b and a path “f” from the change dispensing unit 15b to the ejection port 112. For example, if a 5-yen coin is to be dispensed as change, the 5-yen coin dispensed (path e) from the 5-yen storage 1043 by the change dispensing unit 15b passes through the path f switched by the dispensed-money switching gate 123, and is ejected to the ejection port 112.

As explained above, in the coin/bill dispenser 10 according to the embodiment, the deposited-money conveying path and the dispensed-money conveying path are separately provided, and are independently operated. More specifically, upon receipt of money, the deposited-money conveying path is in an operative state while the dispensed-money conveying path is in a stopped state. Upon dispensing money, the dispensed-money conveying path is in an operative state while the deposited-money conveying path is in a stopped state. Therefore, for example, even if the money is jammed in the side of the deposited-money conveying path to cause failure, the side of the dispensed-money conveying path can be operated without trouble, and thus, the money can be ejected using the dispensed-money conveying path.

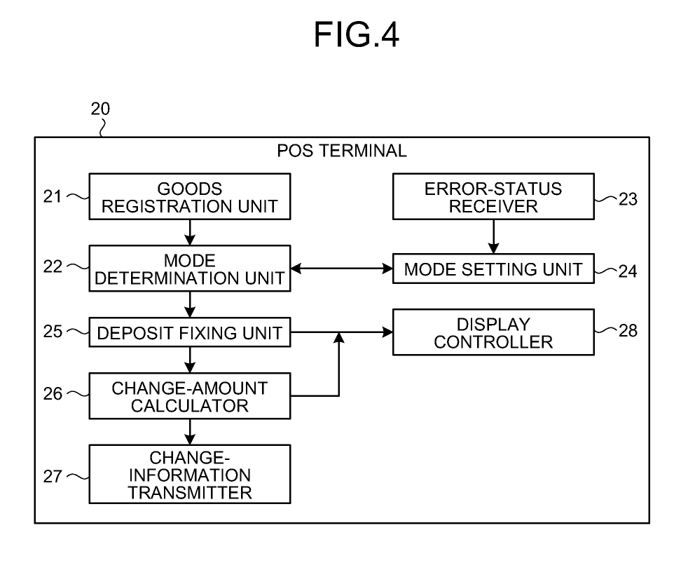

FIG. 4 is a diagram of a functional configuration of the POS terminal 20 according to the embodiment of the present invention. As represented in FIG. 4, the POS terminal 20 includes a goods registration unit 21, a mode determination unit 22, an error-status receiver 23, a mode setting unit 24, a deposit fixing unit 25, a change-amount calculator 26, a change-information transmitter 27, and a display controller 28. The CPU 201 executes a program stored in the memory 202 to function these units.

The goods registration unit 21 executes a goods registration process for adding an sales amount corresponding to purchased goods by using information on goods purchased by the customer sequentially scanned by the bar code scanner 206.

The mode determination unit 22 determines which mode is set to a deposit-amount fixing mode at this time. The deposit-amount fixing mode mentioned here represents a processing mode for fixing an amount of deposit. The deposit-amount fixing mode includes a totalizing input mode and a manual input mode. The totalizing input mode mentioned here represents a mode to fix the amount of money, which has been input into the coin/bill dispenser 10, discriminated and totalized by the coin/bill dispenser 10 as a deposit. The manual input mode mentioned here represents a mode to fix the amount of money input by an operator as the amount of deposit. When it is determined that the deposit-amount fixing mode is the manual input mode after a subtotal key is pressed, the mode determination unit 22 transmits a deposit-acceptance start instruction for instructing to start acceptance of deposit to the coin/bill dispenser 10. The mode determination unit 22 causes the drawer 208 to open when it is determined that the deposit-amount fixing mode is the manual input mode after a total key is pressed.

The error-status receiver 23 receives an error notification and an error release notification sent from the coin/bill dispenser 10.

The mode setting unit 24 sets the deposit-amount fixing mode to the manual input mode when the error notification is received by the error-status receiver 23. Meanwhile, the mode setting unit 24 sets the deposit-amount fixing mode to the totalizing input mode when the error release notification is received by the error-status receiver 23.

When the deposit-amount fixing mode is the totalizing input mode, the deposit fixing unit 25 fixes the amount of deposit included in the deposit information transmitted from the coin/bill dispenser 10 as an amount of money deposited from the customer. Meanwhile, when the deposit-amount fixing mode is the manual input mode, the deposit fixing unit 25 fixes the amount of deposit input by the operator as an amount of money deposited from the customer.

The change-amount calculator 26 calculates the amount of change by using the amount of deposit fixed by the deposit fixing unit 25 and the sales amount totalized by the goods registration unit 21.

The change-information transmitter 27 transmits the change information including the amount of change calculated by the change-amount calculator 26 to the coin/bill dispenser 10.

The display controller 28 displays various types of information on the display 207 with touch panel of the POS terminal 20. The various types of information include the sales amount totalized by the goods registration unit 21, the amount of deposit fixed by the deposit fixing unit 25, and the amount of change calculated by the change-amount calculator 26.

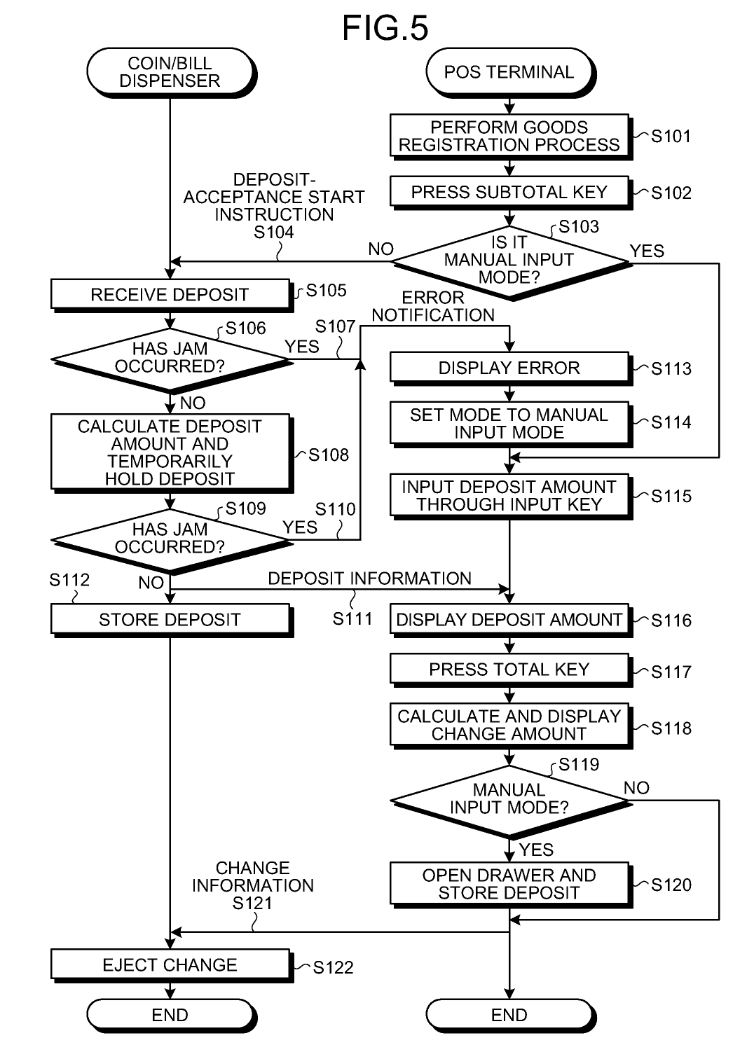

Next, the procedure of the POS system 1 according to the first embodiment is explained below with reference to FIG. 5. FIG. 5 is a flowchart of the procedure of the POS system according to the embodiment of the present invention. This procedure explains how the money is input from the coin/bill dispenser of the POS system and payment is settled when the customer pays for the goods to be purchased.

First, the goods registration unit 21 of the POS terminal 20 executes the goods registration process for adding the sales amount corresponding to the purchased goods by using information on the goods purchased by the customer sequentially scanned by the bar code scanner 206 (Step S101).

Subsequently, when the subtotal key is pressed (Step S102), the mode determination unit 22 of the POS terminal 20 determines whether the deposit-amount fixing mode is set to the manual input mode (Step S103). If the determination is YES (YES at Step S103), the process proceeds to Step S115.

Meanwhile, if it is determined that the deposit-amount fixing mode is set to the totalizing input mode (NO at Step S103), the mode determination unit 22 transmits the deposit-acceptance start instruction to the coin/bill dispenser 10 (Step S104).

Next, when deposit is input through the input port 111 of the coin/bill dispenser 10 (Step S105), the jam detector Ile of the coin/bill dispenser 10 determines whether a jam of the money has occurred at the input port 111 (Step S106). If the determination is YES (YES at Step S106), the error-status transmitter 11f of the coin/bill dispenser 10 transmits an error notification to the POS terminal 20 (Step S107). The POS terminal 20 having received the error notification displays an error massage indicating that the error has occurred in the coin/bill dispenser 10 (Step S113), and the mode setting unit 24 sets the deposit-amount fixing mode to the manual input mode (Step S114).

Meanwhile, if the jam is not detected (NO at Step S106), the money discriminating unit 11a of the coin/bill dispenser 10 discriminates a denomination of the deposit received through the input port 111, and calculates the amount of deposit. The escrow unit 11b of the coin/bill dispenser 10 temporarily holds therein the deposit after the amount of deposit is calculated (Step S108) The jam detector 11e of the coin/bill dispenser 10 determines whether a jam of the money has occurred during the process at Step S108 (Step S109). If the determination is YES (YES at Step S109), the error-status transmitter 11f of the coin/bill dispenser 10 transmits the error notification to the POS terminal 20 (Step S110). The POS terminal 20 having received the error notification displays an error massage indicating the occurrence of an error in the coin/bill dispenser 10 (Step S113), and the mode setting unit 24 sets the deposit-amount fixing mode to the manual input mode (Step S114).

Meanwhile, if the jam of the money is not detected at Step S109 (NO at Step S109), the deposit-information transmitter 11d of the coin/bill dispenser 10 transmits deposit information including the amount of deposit calculated by the money discriminating unit 11a to the POS terminal 20 (Step S111). Thereafter, the deposit sorting unit 11c of the coin/bill dispenser 10 causes the storage device 104 to store therein the deposit held in the escrow unit 11b (Step S112).

If it is determined at Step S103 that the deposit-amount fixing mode is set to the manual input mode (YES at Step S103), the operator operates the input key 203 in the POS terminal 20 to input the amount of deposit (Step S115). Here, if receiving the deposit from the customer, the operator generally checks the amount of deposit and inputs the deposit into the coin/bill dispenser 10. Therefore, if the coin or the bill is jammed, the operator inputs the amount of checked deposit.

Subsequently, the deposit fixing unit 25 of the POS terminal 20 fixes the amount of deposit according to the deposit-amount fixing mode, and the display controller 28 of the POS terminal 20 displays the amount of deposit on the display 207 with touch panel (Step S116). More specifically, when the deposit-amount fixing mode is the totalizing input mode, the amount of deposit included in the deposit information transmitted from the coin/bill dispenser 10 is displayed thereon, while when the deposit-amount fixing mode is the manual input mode, the amount of deposit input by the operator is displayed thereon.

Next, when the total key is pressed (Step S117), the change-amount calculator 26 of the POS terminal 20 calculates the amount of change by using the amount of deposit displayed on the display 207 with touch panel and the sales amount totalized in the goods registration process at Step S10. The display controller 28 of the POS terminal 20 displays the amount of change on the display 207 with touch panel (Step S118).

The mode determination unit 22 of the POS terminal 20 determines whether the deposit-amount fixing mode is set to the manual input mode (Step S119). If the determination is YES (YES at Step S119), the mode determination unit 22 causes the drawer 208 to open, and the operator stores the deposit in the drawer 208 (Step S120).

Meanwhile, if it is determined at Step S119 that the deposit-amount fixing mode is set to the totalizing input mode (NO at Step S119) and when the deposit is stored in the drawer 208 at Step S120, the change-information transmitter 27 of the POS terminal 20 transmits the change information including the amount of change calculated at Step S118 to the coin/bill dispenser 10 (Step S121).

Next, the change dispensing unit 15b of the coin/bill dispenser 10 causes the storage device 104 to dispense the change therefrom based on the amount of change included in the change information, and ejects the change through the ejection port 112 (Step S122).

If the jam occurs when the deposit is stored in the storage device 104 at Step S112, the error-status transmitter 11f of the coin/bill dispenser 10 also transmits the error notification to the POS terminal 20. In this case, the POS terminal 20 already receives the deposit information from the coin/bill dispenser 10 at Step S111, and thus, the deposit information is used to display the amount of deposit on the display 207 with touch panel (Step S116).

As explained above, according to the POS system 1 of the embodiment, when the deposit received through the input port 111 is jammed in the deposited-money conveying device 103 of the coin/bill dispenser 10, the coin/bill dispenser 10 can transmit the error notification indicating detection of the jam of the deposit to the POS terminal 20. The POS terminal 20 having received the error notification sets the deposit-amount fixing mode to the manual input mode, and can transmit the change information including the amount of change calculated by using an input value input by the operator to the coin/bill dispenser 10. The coin/bill dispenser 10 having received the change information can eject the money corresponding to the amount of change included in the change information from the dispensed-money conveying device 105. Thus, even if the jam of the deposit has occurred in the deposited-money conveying device 103 of the coin/bill dispenser 10, the change can be ejected from the dispensed-money conveying device 105 of the coin/bill dispenser 10.

According to the POS system 1 of the embodiment, when the deposit received through the input port 11l is jammed in the deposited-money conveying device 103 after the amount of deposit is totalized, the coin/bill dispenser 10 can transmit the deposit information including the amount of deposit to the POS terminal 20. The POS terminal 20 having received the deposit information can calculate the amount of change by using the amount of deposit included in the deposit information. Thus, an input operation of the amount of deposit performed by the operator can be omitted, which allows improvement of processing efficiency.

Furthermore, according to the POS system 1 of the embodiment, when the jam occurs in the deposited-money conveying device 103 of the coin/bill dispenser 10, the deposit-amount fixing mode can be kept as the manual input mode until the jam error is cleared by fixing or the like. Thus, the operator inputs the amount of deposit, and this allows ejection of the change from the coin/bill dispenser 10. Thus, it is possible to make effective use of the change ejection function performed by the dispensed-money conveying device 105 of the coin/bill dispenser 10.

In the embodiment, the coin/bill dispenser 10 being the change dispenser includes the coin dispenser 10A and the bill dispenser 10B, however, the coin/bill dispenser 10 does not need to include both the coin dispenser and the bill dispenser. The present invention can be applied to a change dispenser that includes only either one of the coin dispenser and the bill dispenser.

Furthermore, in the embodiment, when the jam occurs in the deposited-money conveying device 103 of the coin/bill dispenser 10, the money corresponding to the amount of change is ejected from the dispensed-money conveying device 105, however, it can also be considered that the coin/bill dispenser 10 may run out of money to be dispensed. In this case, for example, dispensing of the change from the coin/bill dispenser 10 may be stopped, an error notification indicating the shortage of the change is transmitted to the 205 terminal 20, and the message indicating the shortage of the change may be displayed on the display 207 with touch panel of the POS terminal 20. Moreover, for example, part of the amount of change may be dispensed using remaining money stored in the storage device 104, while the drawer 208 is opened, and the rest of the amount of the change not dispensed may be taken therefrom and handed over by the operator. In this case, the coin/bill dispenser 10 simply transmits the error notification indicating the shortage of the change and a shortfall to the POS terminal 20, and the POS terminal 20 also simply displays the message indicating the shortage of the change and the shortfall on the display 207 with touch panel. Thus, even if the jam of the deposit has occurred in the deposited-money conveying device 103 of the coin/bill dispenser 10 and even if the storage device 104 runs out of the amount of change, the change can be surely handed over.

According to an aspect of an embodiment, when the money received through the input port is jammed in the deposited-money conveying device of the change dispenser, the change dispenser can transmit the error notification indicating the detection of the jam of the money to the POS terminal. The POS terminal having received the error notification sets the deposit-amount fixing mode to the manual input mode for fixing the input value input by the operator as an amount of deposit, and can transmit change information including the amount of change calculated by using the input value input by the operator to the change dispenser. The change dispenser having received the change information can eject the money corresponding to the amount of change included in the change information from the dispensed-money conveying device. Thus, even if the jam of the deposit has occurred in the deposited-money conveying device of the change dispenser, the change can be ejected from the dispensed-money conveying device of the change dispenser.

According to the embodiment, when the money received through the input port is jammed in the deposited-money conveying device after the amount of deposit is totalized, the change dispenser can transmit deposit information including the amount of deposit to the POS terminal. The POS terminal having received the deposit information can calculate an amount of change by using the amount of deposit included in the deposit information. Thus, an input operation of the amount of deposit performed by the operator can be omitted, which allows improvement of processing efficiency.

According to the embodiment, when the jam has occurred in the deposited-money conveying device 103 of the coin/bill dispenser, the deposit-amount fixing mode can be kept as the manual input mode until the jam error is cleared by fixing or the like. Therefore, the operator inputs the amount of deposit, and this allows ejection of the change from the coin/bill dispenser. Thus, it is possible to make effective use of the change ejection function performed by the dispensed-money conveying device of the coin/bill dispenser.

According to the embodiment, even if the jam of the deposit has occurred in the change dispenser, the change can be ejected from the change dispenser.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A POS system comprising:
a POS terminal; and
a change dispenser, wherein
the change dispenser includes
a storage device that stores therein money;
a deposited-money conveying device that conveys money received through an input port to the storage device;
a dispensed-money conveying device that conveys money dispensed from the storage device to an ejection port;
a detector that detects a jam of money conveyed in the deposited-money conveying device;
an error-notification transmitter that transmits, when the jam of the money is detected by the detector, an error notification indicating the detection of the jam of the money to the POS terminal; and
a dispensing controller that causes, when receiving change information transmitted from the POS terminal as a response to the error notification, the dispensed-money conveying device to eject money corresponding to an amount of change included in the change information, and
the POS terminal includes
a mode setting unit that sets, when receiving the error notification transmitted from the change dispenser, a deposit-amount fixing mode for fixing an amount of deposit to a manual input mode for fixing an input value input by an operator as the amount of deposit;
a change-amount calculator that calculates, when the deposit-amount fixing mode is the manual input mode, an amount of change by using the input value input by the operator; and
a change-information transmitter that transmits the change information including the amount of change calculated by the change-amount calculator to the change dispenser.

2. The POS system according to claim 1, wherein
the change dispenser further includes
a totalizing unit that discriminates a denomination of money received through the input port and totalizes the amount of deposit; and
a deposit-information transmitter that transmits deposit information including the amount of deposit totalized by the totalizing unit to the POS terminal, and
the change-amount calculator of the POS terminal calculates, when receiving the deposit information transmitted from the change dispenser, an amount of change by using the amount of deposit included in the deposit information.

3. The POS system according to claim 2, wherein
the change dispenser further includes
an error-release notification transmitter that transmits, when the jam of the money is cleared, an error release notification indicating clearance of the jam of the money to the POS terminal,
the mode setting unit of the POS terminal sets, when receiving the error release notification transmitted from the change dispenser, the deposit-amount fixing mode to a totalizing input mode in which an amount of the money, having been input into the change dispenser, discriminated and totalized by the change dispenser is fixed as a deposit, and
the change-amount calculator of the POS terminal calculates, when the deposit-amount fixing mode is the totalizing input mode, an amount of change by using the amount of deposit included in the deposit information transmitted from the change dispenser.

4. A method for controlling a POS system including a POS terminal and a change dispenser, the method comprising:
in the change dispenser,
detecting a jam of money in a deposited-money conveying device that conveys the money received through an input port to a storage device;
transmitting, when the jam of the money is detected at the detecting, an error notification indicating the detection of the jam of the money to the POS terminal; and
causing, when receiving change information as a response to the error notification transmitted from the POS terminal, a dispensed-money conveying device to eject money corresponding to an amount of change included in the change information therefrom, the dispensed-money conveying device conveying the money dispensed from the storage device to an ejection port, and
in the POS terminal
setting, when receiving the error notification transmitted from the change dispenser, a deposit-amount fixing mode for fixing an amount of deposit to a manual input mode for fixing an input value input by an operator as the amount of deposit;
calculating, when the deposit-amount fixing mode is the manual input mode, an amount of change by using the input value input by the operator; and
transmitting the change information including the amount of change calculated at the calculating to the change dispenser.

5. The method according to claim 4, further comprising:
in the change dispenser,
discriminating a denomination of money received through the input port;
totalizing the amount of deposit; and
transmitting deposit information including the amount of deposit totalized at the totalizing to the POS terminal, wherein
the calculating in the POS terminal includes calculating, when receiving the deposit information transmitted from the change dispenser, an amount of change by using the amount of deposit included in the deposit information.

6. The method according to claim 5, further comprising
in the change dispenser,
transmitting, when the jam of the money is cleared, an error release notification indicating clearance of the jam of the money to the POS terminal, wherein
the setting in the POS terminal includes setting, when receiving the error release notification transmitted from the change dispenser, the deposit-amount fixing mode to a totalizing input mode in which an amount of the money, having been input into the change dispenser, discriminated and totalized in the change dispenser is fixed as a deposit, and
the calculating in the POS terminal includes calculating, when the deposit-amount fixing mode is the totalizing input mode, an amount of change by using the amount of deposit included in the deposit information transmitted from the change dispenser.

7. A change dispenser connectable to a POS terminal, comprising:
a storage device that stores therein money;
a deposited-money conveying device that conveys money received through an input port to the storage device;
a dispensed-money conveying device that conveys money dispensed from the storage device to an ejection port;
a detector that detects a jam of the money conveyed in the deposited-money conveying device;
an error-notification transmitter that transmits, when the jam of the money is detected by the detector, an error notification indicating the detection of the jam of the money to the POS terminal; and
a dispensing controller that causes, when receiving change information as a response to the error notification transmitted from the POS terminal, the dispensed-money conveying device to eject money corresponding to an amount of change included in the change information therefrom.

8. The change dispenser according to claim 7, further comprising:
a totalizing unit that discriminates a denomination of money received through the input port and totalizes an amount of deposit; and
a deposit-information transmitter that transmits deposit information including the amount of deposit totalized by the totalizing unit to the POS terminal.

9. The change dispenser according to claim 8, further comprising an error-release notification transmitter that transmits, when the jam of the money is cleared, an error release notification indicating the clearance of the jam of the money to the POS terminal.
